(19) United States
(12) Patent Application Publication
(10) Pub. No.: US 2021/0022364 A1
(43) Pub. Date: Jan. 28, 2021

(54) SCRAPER LOCKING ARRANGEMENT

(71) Applicant: 705 SRL, Milano (IT)

(72) Inventors: Alistair John MELDRUM, Ashton Keynes (GB); Giovanni COPPOLA, London (GB)

(73) Assignee: 705 SRL, Milano (IT)

(21) Appl. No.: 16/979,584

(22) PCT Filed: Mar. 13, 2019
(86) PCT No.: PCT/GB2019/050700

§ 371 Date: Sep. 10, 2020

(30) Foreign Application Priority Data
Mar. 13, 2018 (GB) 1803973.5

(51) Int. Cl. A23G 9/12; A23G 9/22

(52) U.S. Cl. CPC A23G 9/12; A23G 9/224

(57) ABSTRACT

The present invention relates to paddle (2) and a scraper disc (1) that is placed in a container and cannot be removed when the paddle and scraper disc are rotating in the operational mode in the container.

The present invention relates to scraper arrangements and in particular but not exclusively to scraper locking arrangements for use with confection making apparatus.

Frozen and cold confections include, but are not exclusive to, dairy and non-dairy ice creams, gelato, sorbets, sherbets, mousses, frozen yogurts, and slush beverages. These confections can be made in bulk but there is a desire to make confections fresh and in a domestic environment with low volumes 0.5 to 2 litres. Such small batches require easy to use apparatus which means easy to assemble and dis-assembly along with cleaning.

It is known to provide a scraper disc with blades for mixing and aerating of a confection with scrapping to force the confection inwardly for churning necessary for making the confection. The components of the confection are located within a packaging carton or may be a bowl then mixed with the disc and blades at one end. Once the confection is made it would ideally be possible to simply remove the disc and blade without too much complexity of action. Simple vertical removal would be ideal.

A locking scraper arrangement in accordance with aspects of the present invention is defined in claim 1 below. Other features of aspects of the present invention are outlined in claims dependent upon claim 1.

An embodiment of aspects of the present invention is described by way of example only with reference to the accompanying drawings in which:—

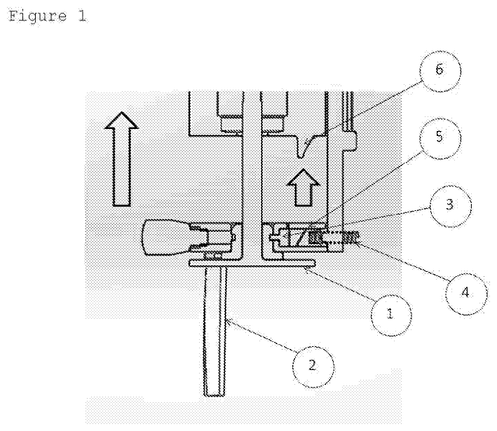

FIG. 1 shows a paddle and scraping disc in the operational position where a locking pin locates into the collar on the paddles to prevent removal; and,

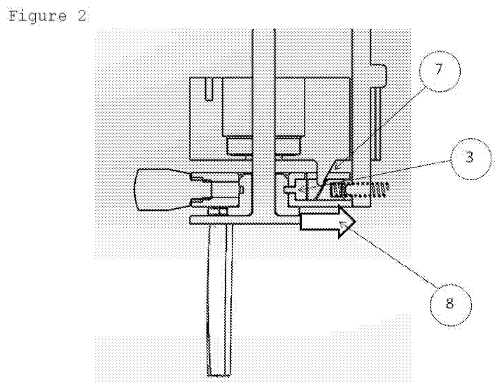

FIG. 2 shows a non-operational position where the locking collar is dis-engaged from the paddle collar to allow removal of the paddles and scraper disc.

Aspects of the present invention relate to the use of a mechanism to lock the paddles and scraper disc to a drive mechanism. This locking mechanism ensures that the paddles and scraper cannot be removed whilst in the operational position but allow unlocking of the paddles and scraper disc when the machine is in a non-operational condition (no confection is being made and the scraper/paddles are not rotated).

Aspects of the present invention make it possible prepare freshly made portions of frozen/cold confections on-demand in much shorter periods of time compared to currently available domestically used ice cream makers. Currently available domestic ice cream makers have paddles which must be removed manually with the press of a button. The present arrangement provides a system which allows free removal of the paddles and scraper disc by use of the natural position when being used.

Aspects of the present arrangement use a click in and out mechanism. The in and out mechanism is only allowed to operate by means of a locking pin when in the paddles are in an operational position within the scraper disc but allows the paddles and scraper disc to be removed when in the non operational position.

With aspects of the present invention as can be seen in the figures a paddle (2) and scraper disc (1) are locked in place by a pin (3) held under compression by a material which act as a spring (4). The spring 4 or bias locks the paddles and scraper disc when the paddles are engaged with packaging (not shown). The paddles 2 and scraper disc 1 are held in this operational position (see FIG. 1).

When the paddles 2 and scraper disc 1 are lifted together to the non-operational position then a protrusion on a drive head (6) is allowed to engage with the locking pin (3) through a slot (5) or window. This engagement (7) applies an urging force to the locking pin (3) which in turn disengages the pin 3 from a paddle collar (8) and allows the paddles 2 and scraper disc 1 to be removed.

In such circumstances the paddle 2 and scraper disc 1 cannot be removed when in its operational position. Thus aspects of the present invention relate to a paddle (2) and a scraper disc (1) combination which are locked in place when the machine is in the operational position (FIG. 1) and are unlocked by lifting to allow for removal and cleaning when in the non-operational position (FIG. 2).

In accordance with aspects of the present invention the amount of lift is over a distance of about 71 mm although this could be more or less if the packaging or chamber dimensions were altered. The distance of the lift is related to the length of the paddles as they need to clear the packaging so that the drive head can be moved away to allow for packaging removal from the system.

Typically, in accordance with aspects of the present invention there is no downward bias such as a mechanical spring to give a specific down force for the blades into the packaging. The arrangement depends upon gravity, that is to say the mass of the blades, scraper disc and parts of the driving mechanism acting under gravity down into the carton or bowl, but it is envisaged that is may be possible to provide paddles which are sprung loaded downward against the walls of the packaging. In such circumstance there may be advantages in providing a downward force and even a locking mechanism for keep all the components (packaging and paddles) tight against each other and tight to the cooling chamber as the angle of the cooling chamber would work against a sprung loaded system.

The paddles and scraper disc do not stay with the chilled confection but are moved away, typically to the right hand side of the machine as depicted, so that the packaging carton can be removed manually with the confectionary in it.

The drive angle for the locking pin surface is about 30 degrees with a distance of locking engagement is in the order of 5.5 mm but as will be appreciated specific choice of angle, displacement distance and other factors will depend upon what is necessary in a particular embodiment.

### REFERENCE ANNOTATIONS

(1) a scraper disc
(2) a paddle
(3) a locking pin
(4) a spring mechanism
(5) a slot
(6) a pin
(7) an engagement
(8) an axial movement

1. A locking arrangement for scraper discs, the arrangement comprising a locking pin laterally bias to an operational position for engagement across a recess in a disc whereby the disc is locked to a drive mechanism, a release pin in the drive mechanism is disposed above the locking pin and a slot in the disc is above the locking pin, the disc and the release pin are relatively displaceable to each other by lift whereby the release pin penetrates the slot in use towards the locking pin and engages a slanted surface of the locking pin at an angle such that the locking pin is displaced laterally upon the angle of the slanted surface by the drive of the release pin in the recess on that surface and against the lateral bias so removing the locking pin from the disc to release the disc.

2. The locking arrangement of claim 1, wherein the engagement between the release pin and the locking pin is held when the disc is released.

3. The locking arrangement of claim 1, wherein the disc also has blades.

4. The locking arrangement of claim 1, wherein the lateral bias is provided by a mechanical spring.

5. The locking arrangement of claim 1, wherein the release pin is fixed and the disc is displaceable by lift towards it.

6. The locking arrangement of claim 1, wherein the release pin is shaped or moulded into a mounting with the release pin protruding downwards.

7. The locking arrangement of claim 1, wherein the relative displacement by lift of the disc and the release pin is substantially perpendicular to the displacement laterally against the bias.

8. The locking arrangement of claim 1, wherein an end of the release pin and/or the slanted surface of the locking pin are shaped and configured to allow any necessary motion to facilitate displacement laterally against the bias of the locking pin.

9. The locking arrangement of claim 1, wherein the slanted surface has an angle greater than 45 degrees to a perpendicular to the lateral displacement.

10. The locking arrangement of claim 1, wherein the arrangement is part of apparatus to form a confection such as ice cream in packaging or a bowl.
